(19) United States
(12) Patent Application Publication
(10) Pub. No.: US 2024/0386256 A1
(43) Pub. Date: Nov. 21, 2024

(54) Sparse Mixer Architecture

(71) Applicant: Google LLC, Mountain View, CA (US)

(72) Inventors: James Lee Thorp, Brentwood, TN (US); Joshua Timothy Ainslie, San Francisco, CA (US)

(21) Appl. No.: 18/318,049

(22) Filed: May 16, 2023

(51) Int. Cl. G06N 3/0499

(52) U.S. Cl. CPC G06N 3/0499

(57) ABSTRACT

Improved multi-layer machine learning model architectures are provided that exhibit increased accuracy, decreased training time, decreased inference compute cost, and/or increased stability while training. These improved models include a plurality of sequential layers, each layer comprising a mixing layer that feeds into a feedforward layer. These improved models achieve these benefits by ‘enhancing’ a subset of the feedforward layers with mixture-of-experts or other sparse multi-network architectures while ‘degrading’ a subset of the mixing layers to be simple linear mixing layers (e.g., that multiply inputs by one or more mixing matrices) rather than more complicated attentional mixing mechanisms (e.g., including a number of matrix multiplications, dot products, and nonlinear operations). Such a combination of mixing layer modifications and feedforward layer modifications in a single multi-layer model exhibits synergistic improvements with respect to training time, inference computational cost, and training stability for a given level of model accuracy.

### BACKGROUND

Artificial neural networks, convolutional neural networks, transformers, deep learning models, and/or other machine learning models can be used to classify inputs, to filter or otherwise modify inputs, to project inputs into a semantically relevant or otherwise useful embedding space, to generate textual responses to input text, to assess sentiment in input text, or to provide other beneficial outputs from applied inputs. The accuracy of a given machine learning model structure can often be increased by increasing the parameter count and/or complexity of the model. However, such expanded parameter counts can increase the computational cost (cycles, time, power, memory, interconnect bandwidth) of executing and/or training the model, increase the amount of training data needed to train the model, reduce the stability of the model when training the model, or other undesired effects. It is desirable to develop machine learning models that exhibit reduced complexity (e.g., parameter count, computational cost of execution/training) while maintaining accuracy, stability, or other desirable qualities.

### SUMMARY

In a first aspect, a method is provided that includes executing a machine learning model to generate an output from an input, wherein the machine learning model comprises a plurality of layers organized in order such that each layer of the plurality of layers receives as an input the output from a previous layer and/or provides an output to a subsequent layer as an input thereto, wherein a given layer of the plurality of layers comprises (i) a mixing sub-layer that receives an input set of vectors to the given layer and generates therefrom an intermediate set of vectors of the given layer and (ii) a feedforward sublayer that receives as an input the intermediate set of vectors of the given layer and generates therefrom an output set of vectors of the given layer. Executing the machine learning model includes: (i) executing a first mixing sublayer of the machine learning model by applying a linear mixing mechanism to generate an intermediate set of vectors therefrom; and (ii) executing a first feedforward sublayer of the machine learning model by applying a plurality of different nonlinear feedforward networks to generate, from respective sets of one or more vectors of an intermediate set of vectors input to the first feedforward sublayer, respective sets of one or more output vectors of a set of output vectors output from the first feedforward sublayer.

In another aspect, a method is provided that includes training a machine learning model to generate an output from an input, wherein the machine learning model comprises a plurality of layers organized in order such that each layer of the plurality of layers receives as an input the output from a previous layer and/or provides an output to a subsequent layer as an input thereto, wherein a given layer of the plurality of layers comprises (i) a mixing sub-layer that receives an input set of vectors to the given layer and generates therefrom an intermediate set of vectors of the given layer and (ii) a feedforward sublayer that receives as an input the intermediate set of vectors of the given layer and generates therefrom an output set of vectors of the given layer, a first mixing sublayer of the machine learning model uses a linear mixing mechanism to generate an intermediate set of vectors therefrom, and wherein a first feedforward sublayer of the machine learning model uses a plurality of different nonlinear feedforward networks to generate, from respective sets of one or more vectors of an intermediate set of vectors input to the first feedforward sublayer, respective sets of one or more output vectors.

In another aspect an article of manufacture is provided that includes a non-transitory computer-readable medium, having stored therein instructions executable by a computing device to cause the computing device to perform the above methods.

In another aspect a system is provided that includes: (i) one or more processors; and (ii) a non-transitory computer-readable medium, having stored therein instructions executable by the one or more processors to cause the system to perform the above methods.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE FIGURES

FIG. 1A illustrates aspects of a multi-layer machine learning model, according to an example embodiment.

FIG. 1B illustrates aspects of a multi-layer machine learning model, according to an example embodiment.

FIG. 2 is a diagram illustrating training and inference phases of a machine learning model, in accordance with example embodiments.

FIG. 3 is a simplified block diagram showing some of the components of an example computing system.

FIG. 4 is a flowchart of a method.

FIG. 5 illustrates example experimental results.

### DETAILED DESCRIPTION

Examples of methods and systems are described herein. It should be understood that the words “exemplary,” “example,” and “illustrative,” are used herein to mean “serving as an example, instance, or illustration.” Any embodiment or feature described herein as “exemplary,” “example,” or “illustrative,” is not necessarily to be construed as preferred or advantageous over other embodiments or features. Further, the exemplary embodiments described herein are not meant to be limiting. It will be readily understood that certain aspects of the disclosed systems and methods can be arranged and combined in a wide variety of different configurations.

### I. Overview

A variety of machine learning model types and associated training methods have been developed in order to generate outputs from inputs in a variety of applications. Such models have been developed to be able to accurately predict class values, segmentation maps, language translations, sentiment and/or semantic content of text, or other outputs from text, token sequences, images, feature vectors, or other inputs.

Transformers and other multi-layer machine learning model architectures have become popular for processing input sequences, e.g., text, in a manner that allows content at any locations of the input sequence to influence processing related to content at any other location within the input sequence, without the diminishing memory effects and related training difficulties exhibited by long short-term memory networks or other recurrent model architectures. These multi-layer model architectures achieve this benefit by including, in each layer of the model, a mixing sublayer that allows each input to be influenced (or ‘mixed’) with other layer inputs (this ‘mixing’ may alternatively be referred, in certain implementations, as ‘attention’) before being processed by a feedforward sublayer to generate the overall layer output. This process of mixing and then individual feedforward processing is repeated with each layer (applying different mixing matrices/weights and different feedforward weights with each layer) to result in a set of output vectors that represent semantic or other informational content of the input sequence (e.g., a sequence of tokens determined by tokenizing an input text string, a set of input vectors determined by embedding such tokens into an embedding space). This output can then be used to, e.g., generate a translation of input text (e.g., by applying the output vectors to a decoder that is, in some ways, configured as the ‘reverse’ of the encoder used to generate the output), to search for semantically similar text or other sequences and/or to cluster such sequences in a semantically-aware manner, or according to some other application.

The accuracy of such models is related to a variety of factors, including the amount and type of training data used to train the models, the methods used to perform that training, the structure of the models, and the size and/or number of parameters of the models, among other factors. A common method to increase the accuracy of a particular model or model type is to increase the number of parameters of the model. This can include representing input tokens by a higher-dimensional embedding space (with accompanying increases in the number of model parameters needed to perform computation on the additional dimensions), adding additional layers to the model, adding additional ‘heads’ to attention mechanisms of the model, increasing a number of layers of units in one or more feedforward sublayer artificial neural networks, or some other expansion of the model that results in additional trainable model parameters. However, such increases in model parameter count can increase the time needed to train such a model, the amount of training data needed to train the model, the amount of computational resources (e.g., memory, cycles) needed to execute the trained model at inference time, the amount of time/latency needed to execute the trained model at inference time, etc.

An example of architectures exhibiting increased parameter count is the use, in a feedforward sublayer, of multiple different feedforward models to process the intermediate output of a mixing sublayer. Individual vectors of the intermediate output can be routed to the different networks, e.g., according to the different ‘expertise’ of each of the different network with respect to different regions of the intermediate vector space. For example, the multiple different networks could comprise a ‘mixture of experts’ model, with each one of the networks being trained to ‘expertise’ with respect to a different region of the intermediate vector space. However, the addition of such additional models results in increased training time and increased training data requirements. Additionally, the training of ‘mixture of experts’ models or similar routed multi-model architectures can exhibit increased instability relative to, e.g., the training of single-model feedforward sublayers.

Conversely, to reduce training time, training data requirements, and/or the computational cost of executing the trained model for inference, the model can be simplified. For example, by reducing parameter count (though such a reduction may result in reduced model accuracy). This can include using linear mixing sublayers (e.g., including one or more matrices to multiply across and/or along the input vectors, using a Fourier, Hartley, or other transform to transform the input along one or both dimensions of the input) to replace one or more attention sublayers (e.g., multi-head self-attention layers, with their multiple matrices (e.g., key and query matrices), weight vectors, scaling factors, head concatenation and summation networks, and/or other parameter-including elements).

The combination of ‘degrading’ some of the mixing sublayers by replacing attention mechanisms with linear mixing mechanisms while ‘enhancing’ some of the feedforward sublayers by replacing simple single-model feedforward sublayers with multi-model feedforward sublayers (e.g., mixture-of-experts or other routed multi-model architectures) results in models that exhibit, for similar levels of accuracy, reduced training time, reduced training data requirements, and reduced inference-time computational costs. It is a synergy between the linear mixing sublayers and the multi-model feedforward sublayers that results in these benefits, especially for certain arrangements of the linear mixing sublayers and multi-model feedforward sublayers. Additionally, this synergy resulted in increased model stability during training relative to models that include multi-model feedforward sublayers and attention mixing sublayers. The increased inference-time computation cost of the multi-model feedforward sublayers is offset by the reduced inference-time computation cost of the linear mixing sublayers.

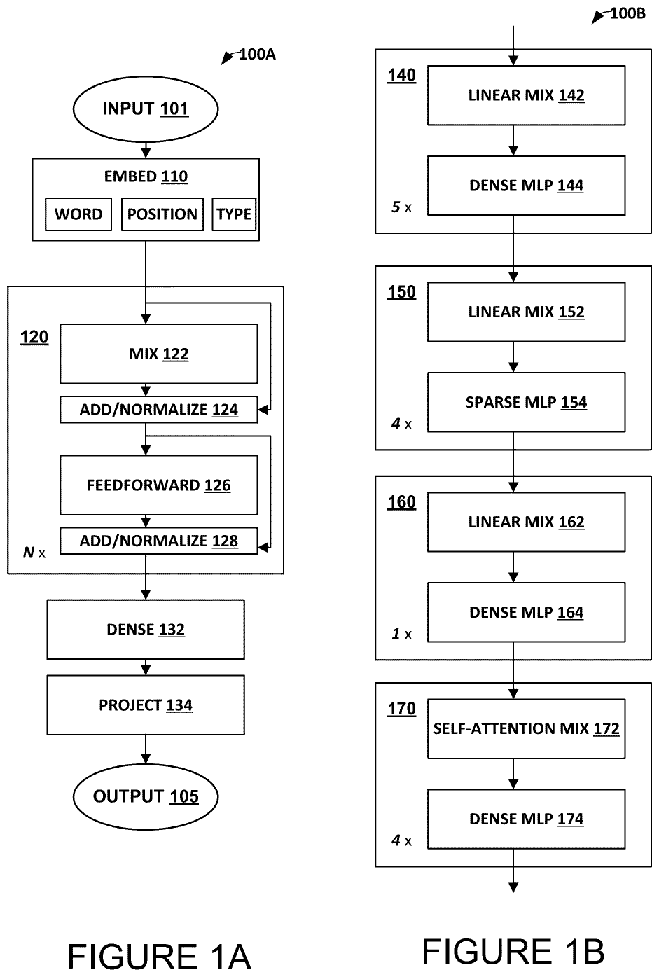

FIG. 1A depicts elements of an example machine learning model 100A. The model 100A includes N layers 120, each layer including a mixing sublayer 122 that receives an input to the layer 120 and generates an intermediate output that is then applied to a feedforward sublayer 126 of the layer to generate an output of the layer 120. As shown by way of non-limiting example, the layers 120 include feedforward connections in which the raw input to the layer 120 is added to the output of the mixing sublayer 122 and normalized (“ADD/NORMALIZE” 124) to generate the intermediate output that is then provided as an input to the feedforward sublayer 126. A feedforward connection is also provided around the feedforward sublayer 126, with the intermediate output being added to the output of the feedforward mixing sublayer 126 and normalized (“ADD/NORMALIZE” 126) to generate the final output of the layer 120.

Also by way of non-limiting example, the input 101 to the model 100A is transformed into a set of input vectors to the first layer 120 by mapping each token or other symbol of the input sequence 101 to a respective embedding vector of an input set of vectors that is provided to the first layer 120. This embedding process (“EMBED” 110) can include using a mapping to generate a word vector or similar representative vector embedding for each token (“WORD”), generating a position vector that represents the token's position in the input sequence 101 (“POSITION”), generating vectors or scalars that represent a type of each token of the input sequence 101 (“TYPE”), and/or concatenating, summing, or otherwise combining such vectors together to generate a single vector representing each token of the input sequence 101.

Also by way of non-limiting example, the overall output 105 of the model 100A is generated by applying the output from the final layer 120 to at least one additional layer (e.g., a “DENSE” 132 feedforward layer that applies at least one neural network or other model element to each vector of the final layer output to generate respective output scalars/vectors, a dense projection/matrix multiplication, or other final processing step(s)). The output of the at least one additional feedforward layer 134 is then projected into an output space (“PROJECT” 134) by, e.g., applying a mapping, performing a threshold operation, performing a clustering operation, etc. to generate the output 105 of the overall model 105. Such an output 105 could then be used to perform some additional computation/application, e.g., applied to a decoder to generate a translation or refactoring of the input 101, used to perform a search or indexing function to identify other strings/sequences similar to the input 101 (e.g., to identify clusters of such sequences that are semantically similar or related), etc.

At least one of the feedforward sublayers 126 receives a set of intermediate vectors from the immediately preceding mixing sublayer 122 and then applies a plurality of different nonlinear feedforward networks to generate, from respective sets of one or more vectors of the intermediate set of vectors, respective sets of one or more output vectors that are then passed on to the next layer 120 (or, in the case of the terminal layer, to the dense layer 132), optionally after adding the feedforward sublayer output to the set of intermediate vectors and then normalizing the sum (128). The remainder of the feedforward sublayers 126 receive respective sets of intermediate vectors from respective immediately preceding mixing sublayers 122 and apply respective single nonlinear feedforward networks (e.g., an artificial neural network) to all of the vectors of their respective sets of intermediate vectors to generate respective layer outputs (which are optionally added to the respective sets of intermediate vectors and normalized to generate the overall layer outputs).

Note that, while the example model depicted in FIG. 1A includes normalization of layer outputs (“post-normalization”), a model as described herein could additionally or alternatively include normalization of inputs to one or more layers hereof (“pre-normalization”).

The at least one of the feedforward sublayers 126 that are configured to apply a plurality of different nonlinear feedforward networks to generate their respective outputs could be configured as ‘mixture of experts’ models or as some other form of multi-model architecture wherein input vectors are routed to the different nonlinear feedforward networks by, e.g., executing a router algorithm. This could include determining, for each vector of an input set of intermediate vectors, a ‘preferred’ one or more of the different nonlinear feedforward networks (e.g., based on distance within a vector space to locations that represent locations of ‘expertise’ of each of the networks within the vector space, based on the location of the input vectors within the vector space being within regions of ‘expertise’ of each of the networks within the vector space) and then applying each intermediate vector's set of one or more ‘preferred’ networks to process each intermediate vector (with the outputs being added and normalized in the case that multiple preferred networks are applied to each intermediate vector in order to generate a single output for each intermediate vector). This routing mechanism can be referred to as “tokens choose” routing. Alternatively, executing the routing algorithm could include determining, for each ‘expert’ model of the different nonlinear feedforward networks, a set of one or more preferred vectors of the input set of intermediate vectors (e.g., based on distance within a vector space to locations that represent locations of ‘expertise’ of each of the networks within the vector space, based on the location of the input vectors within the vector space being within regions of ‘expertise’ of each of the networks within the vector space). This routing mechanism can be referred to as “experts choose” routing.

The choice of the type of routing, and of specific parameters of the routing (e.g., the number of ‘preferred’ vectors that are assigned to each of the ‘experts’), can be selected to provide various benefits. Since expert capacities are, in practice, sometimes limited, the use of “tokens choose” routing can result in some tokens not being processed by all of their preferred experts, and also in some experts not being used to process any tokens, resulting in inefficient use of computational resources. The routing algorithm can be adapted to include a load balancing loss to account for these issues. In contrast, ‘experts choose’ routing results in a constant load on each expert (equal to whatever the ‘capacity factor’ of the experts is set to), but may result in many input vectors not being computed by any experts while some may be computed by multiple. However, in either routing scheme, vectors that are not processed by any experts may still be represented in overall layer output due to the optional addition and normalization step including information from the un-processed intermediate vectors.

At least one of the mixing sublayers 122 receives a set of input vectors from the immediately preceding layer 120 (or from the embedding process 110, in the case of the initial layer 120) and then applies a linear mixing mechanism thereto to generate an output intermediate set of vectors that are then passed on to the subsequent feedforward sublayer 126, optionally after adding the mixing sublayer output to the set of input vectors and then normalizing the sum (124). The remainder of the mixing sublayers 122 receive respective sets of input vectors from respective immediately preceding layer 120 (or from the embedding process 110, in the case of the initial layer 120) and apply respective attention or other along-the-sequence mixing mechanisms thereto to generate respective intermediate set of vectors that are then passed on to the subsequent feedforward sublayer 126, optionally after adding the mixing sublayer output to the set of input vectors and then normalizing the sum (124). Such attention mechanisms could include single-or multi-head self-attention mechanisms.

The at least one of the mixing sublayers 122 that applies a linear mixing mechanism to mix the input vectors could use a variety of different methods to accomplish linear mixing between the input vectors. The applied mixing mechanism could optionally also apply mixing along the lengths of the individual input vectors. For example, a linear transformation (e.g., a Fourier transformation, a Hartley transformation) could be applied across the vectors of the set of input vectors to mix them. Optionally, such a transform could additionally be applied along the lengths of the input vectors to provide mixing along the vectors as well. In another example, the linear mixing mechanism could pre-and/or post-multiply the set of input vectors by one or two matrices to accomplish linear mixing across the input vectors (and optionally along their lengths). The one (or two) matrices used for this multiplication could be unconstrained during training (such that each element of each matrix is able to be modified independently of the other elements), or could be constrained in some manner to reduce the effective number of trained parameters (e.g., the matrices could be Toeplitz matrices, diagonal matrices, circulant matrices, or some other variety of constrained matrix).

Certain arrangements of linear mixing sublayers and multi-model feedforward sublayers within an overall multi-layer model can provide additional benefits with respect to the accuracy, training time, amount of required training data, training stability, and/or inference-time computational cost. For example, at least one layer of a multi-layer model could include both a linear mixing sublayer (e.g., pre-and/or post-multiplication of input vectors by one or two trained matrices) and a multi-model feedforward sublayer (e.g., a mixture-of-experts model that includes routing of input vectors to experts). It is generally more beneficial to have linear mixing sublayers in the initial layer(s) of a multi-layer model and attention layers (e.g., single-or multi-head self-attention layers) in the terminal layer(s) of the multi-layer model. It is generally more beneficial for the middle layer(s) of a multi-layer model to have multi-model feedforward sublayers and single-model feedforward sublayers in the initial layer(s) and terminal layer(s) of the multi-layer model.

FIG. 1B shows an example organization of the layers of a multi-layer model 100B as described herein. Note that FIG. 1B only shows the configuration of the repeating multi-layer portion of the model 100B (corresponding generally to the layers 120 of the model 100A depicted in FIG. 1A), and omits any input mechanisms (e.g., embedding tokens of an input sequence into a vector space to generate a set of input vectors to the first layer of the repeating layer portion of the model 100B) or output mechanisms (e.g., output dense layers, projection mechanisms, decoders, or other elements that might receive an output set of vectors generated from the terminal layer of the repeating layer portion of the model 100B).

The repeating multi-layer portion of the model 100B begins with an initial five layers 140 that have linear mixing sublayers 142 and that apply respective single feedforward network to all intermediate vectors in the feedforward sublayers 144 (e.g., in the form of respective multi-layer perceptrons (MLP)) to generate sets of output vectors from each of the five layers 140.

The repeating multi-layer portion of the model 100B continues with a further four layers 150 that have linear mixing sublayers 152 and that apply respective sets of different feedforward networks to sets of their respective sets of intermediate vectors in the feedforward sublayers 154 (e.g., in the form of sparsely-routed mixture-of-experts models, with each of the experts, e.g., being in the form of different multi-layer perceptrons (MLP)) to generate sets of output vectors from each of the four layers 150.

The repeating multi-layer portion of the model 100B continues with a further single layer 160 that includes a linear mixing sublayer 162 and that applies a single feedforward network to all intermediate vectors in the feedforward sublayer 164 (e.g., in the form of a multi-layer perceptron (MLP)) to generate a sets of output vectors from the layer 160.

The repeating multi-layer portion of the model 100B terminates with a final four layers 170 that have nonlinear attention mixing sublayers 142 (e.g., single-or multi-head self-attentional mechanism mixing sublayers) and that apply respective single feedforward networks to all intermediate vectors in the feedforward sublayers 174 (e.g., in the form of respective multi-layer perceptrons (MLP)) to generate sets of output vectors from each of the four layers 170.

A multi-layer model as described herein can also be improved in a variety of other ways, e.g., by selecting certain model hyperparameters that provide additional benefits with respect to accuracy, training time, amount of required training data, training stability, and/or inference-time computational cost. For example, multi-layer models as described herein (including at least one layer having a linear mixing sublayer and at least one layer having a set of different feedforward networks that are applied to respective sets of layer intermediate vectors) can be improved by having more layers that are ‘narrower’ in the length of the vectors passed from layer to layer. For example, such a model could have at least 14 layers, and the lengths of vectors in the sets of vectors passed from layer to layer thereof are all less than or equal to 512.

### II. Example Machine Learning Models and Training Thereof

A machine learning model as described herein may include, but is not limited to: an artificial neural network (e.g., Transformers, layered models wherein each layer includes two or more sub-layers one or more of which could include artificial neural networks, convolutional neural networks, a recurrent neural network, a Bayesian network, a hidden Markov model, a Markov decision process, a logistic regression function, a support vector machine, a suitable statistical machine learning algorithm, and/or a heuristic machine learning system), a support vector machine, a regression tree, an ensemble of regression trees (also referred to as a regression forest), a decision tree, an ensemble of decision trees (also referred to as a decision forest), or some other machine learning model architecture or combination of architectures.

An artificial neural network (ANN) could be configured in a variety of ways. For example, the ANN could include two or more layers, could include units having linear, logarithmic, or otherwise-specified output functions, could include fully or otherwise-connected neurons, could include recurrent and/or feed-forward connections between neurons in different layers, could include filters or other elements to process input information and/or information passing between layers, or could be configured in some other way to facilitate the processing of input sequences, sets of embedding vectors representing input sequences, downstream vectors and/or set of vector determined by the operation of one or more layers or sublayers of a multi-layer model, and/or individual vectors (e.g., embedding vectors representing tokens of an input sequence, downstream vectors representing the processing of such embedding vectors by one or more layers or sublayers of a multi-layer model).

An ANN could include one or more filters that could be applied to the input and the outputs of such filters could then be applied to the inputs of one or more neurons of the ANN. For example, such an ANN could be or could include a convolutional neural network (CNN). Convolutional neural networks are a variety of ANNs that are configured to facilitate ANN-based classification or other processing based on images or other large-dimensional inputs whose elements are organized within two or more dimensions. The organization of the ANN along these dimensions may be related to some structure in the input structure (e.g., as relative location within the one-dimensional space of sequence of tokens can be related to similarity or relevance between tokens of the sequence).

In example embodiments, a CNN includes at least one two-dimensional (or higher-dimensional) filter that is applied to an input; the filtered input is then applied to neurons of the CNN (e.g., of a convolutional layer of the CNN). The convolution of such a filter and an input could represent the color values of a pixel or a group of pixels from the input, in embodiments where the input is an image. A set of neurons of a CNN could receive respective inputs that are determined by applying the same filter to an input. Additionally or alternatively, a set of neurons of a CNN could be associated with respective different filters and could receive respective inputs that are determined by applying the respective filter to the input. Such filters could be trained during training of the CNN or could be pre-specified. For example, such filters could represent wavelet filters, center-surround filters, biologically-inspired filter kernels (e.g., from studies of animal visual processing receptive fields), or some other pre-specified filter patterns.

A CNN or other variety of ANN could include multiple convolutional layers (e.g., corresponding to respective different filters and/or features), pooling layers, rectification layers, fully connected layers, or other types of layers. Convolutional layers of a CNN represent convolution of an input image, or of some other input (e.g., of a filtered, downsampled, or otherwise-processed version of an input image), with a filter. Pooling layers of a CNN apply non-linear downsampling to higher layers of the CNN, e.g., by applying a maximum, average, L2-norm, or other pooling function to a subset of neurons, outputs, or other features of the higher layer(s) of the CNN. Rectification layers of a CNN apply a rectifying nonlinear function (e.g., a non-saturating activation function, a sigmoid function) to outputs of a higher layer. Fully connected layers of a CNN receive inputs from many or all of the neurons in one or more higher layers of the CNN. The outputs of neurons of one or more fully connected layers (e.g., a final layer of an ANN or CNN) could be used to determine information about areas of an input image (e.g., for each of the pixels of an input image) or for the image as a whole.

Neurons in a CNN can be organized according to corresponding dimensions of the input. For example, where the input is a sequence of token (a one-dimensional input, with each token representing one or more words, or fractions of words, in an input text string), neurons of the CNN (e.g., of an input layer of the CNN, of a pooling layer of the CNN) could correspond to locations in the one-dimensional input string/sequence. Connections between neurons and/or filters in different layers of the CNN could be related to such locations.

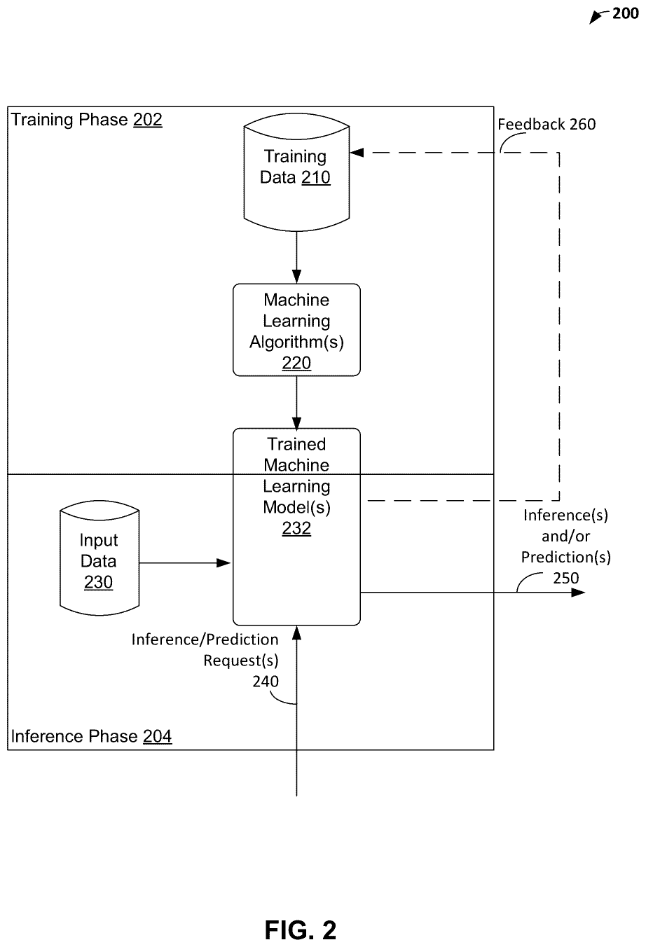

FIG. 2 shows diagram 200 illustrating a training phase 202 and an inference phase 204 of trained machine learning model(s) 232, in accordance with example embodiments. Some machine learning techniques involve training one or more machine learning algorithms, on an input set of training data to recognize patterns in the training data and provide output inferences and/or predictions about (patterns in the) training data. Such output could take the form of filtered or otherwise modified versions of the input, e.g., an input sequence that represents text in a source language could be modified by the machine learning model into (i) an output sequence that represents text in a target language that has similar meaning or semantic content as the input sequence and/or (ii) an output set of embedding vectors that represent, in a semantic embedding space, the meaning or semantic content of the input sequnce. The resulting trained machine learning algorithm can be termed as a trained machine learning model. For example, FIG. 2 shows training phase 202 where one or more machine learning algorithms 220 are being trained on training data 210 to become trained machine learning model 232. Then, during inference phase 204, trained machine learning model 232 can receive input data 230 and one or more inference/prediction requests 240 (perhaps as part of input data 230) and responsively provide as an output one or more inferences and/or predictions 250.

As such, trained machine learning model(s) 232 can include one or more models of one or more machine learning algorithms 220. Machine learning algorithm(s) 220 may include, but are not limited to: an artificial neural network (e.g., a herein-described convolutional neural networks, a recurrent neural network, a Bayesian network, a hidden Markov model, a Markov decision process, a logistic regression function, a support vector machine, a suitable statistical machine learning algorithm, and/or a heuristic machine learning system), a support vector machine, a regression tree, an ensemble of regression trees (also referred to as a regression forest), a decision tree, an ensemble of decision trees (also referred to as a decision forest), or some other machine learning model architecture or combination of architectures. For example, the trained machine learning model(s) 232 could include a plurality of artificial neural networks and other elements related to such networks (e.g., mixing or weighting matrices, sums, products, feedforward connections) arranged according to the multi-layer and sublayer architecture of a Transformer or similar model architecture designed to process input sequences. Machine learning algorithm(s) 220 may be supervised or unsupervised, and may implement any suitable combination of online and offline learning.

In some examples, machine learning algorithm(s) 220 and/or trained machine learning model(s) 232 can be accelerated using on-device coprocessors, such as graphic processing units (GPUs), tensor processing units (TPUs), digital signal processors (DSPs), and/or application specific integrated circuits (ASICs). Such on-device coprocessors can be used to speed up machine learning algorithm(s) 220 and/or trained machine learning model(s) 232. In some examples, trained machine learning model(s) 232 can be trained, reside and execute to provide inferences on a particular computing device, and/or otherwise can make inferences for the particular computing device.

During training phase 202, machine learning algorithm(s) 220 can be trained by providing at least training data 210 as training input using unsupervised, supervised, semi-supervised, and/or reinforcement learning techniques. Unsupervised learning involves providing a portion (or all) of training data 210 to machine learning algorithm(s) 220 and machine learning algorithm(s) 220 determining one or more output inferences based on the provided portion (or all) of training data 210. Supervised learning involves providing a portion of training data 210 to machine learning algorithm(s) 220, with machine learning algorithm(s) 220 determining one or more output inferences based on the provided portion of training data 210, and the output inference(s) are either accepted or corrected based on correct results associated with training data 210. In some examples, supervised learning of machine learning algorithm(s) 220 can be governed by a set of rules and/or a set of labels for the training input, and the set of rules and/or set of labels may be used to correct inferences of machine learning algorithm(s) 220.

Semi-supervised learning involves having correct results for part, but not all, of training data 210. During semi-supervised learning, supervised learning is used for a portion of training data 210 having correct results, and unsupervised learning is used for a portion of training data 210 not having correct results. Reinforcement learning involves machine learning algorithm(s) 220 receiving a reward signal regarding a prior inference, where the reward signal can be a numerical value. During reinforcement learning, machine learning algorithm(s) 220 can output an inference and receive a reward signal in response, where machine learning algorithm(s) 220 are configured to try to maximize the numerical value of the reward signal. In some examples, reinforcement learning also utilizes a value function that provides a numerical value representing an expected total of the numerical values provided by the reward signal over time. In some examples, machine learning algorithm(s) 220 and/or trained machine learning model(s) 232 can be trained using other machine learning techniques, including but not limited to, incremental learning and curriculum learning.

In some examples, machine learning algorithm(s) 220 and/or trained machine learning model(s) 232 can use transfer learning techniques. For example, transfer learning techniques can involve trained machine learning model(s) 232 being pre-trained on one set of data and additionally trained using training data 210. More particularly, machine learning algorithm(s) 220 can be pre-trained on data from one or more computing devices and a resulting trained machine learning model provided to computing device CD1, where CD1 is intended to execute the trained machine learning model during inference phase 204. Then, during training phase 202, the pre-trained machine learning model can be additionally trained using training data 210, where training data 210 can be derived from kernel and non-kernel data of computing device CD1. This further training of the machine learning algorithm(s) 220 and/or the pre-trained machine learning model using training data 210 of CD1's data can be performed using either supervised or unsupervised learning. Once machine learning algorithm(s) 220 and/or the pre-trained machine learning model has been trained on at least training data 210, training phase 202 can be completed. The trained resulting machine learning model can be utilized as at least one of trained machine learning model(s) 232.

In particular, once training phase 202 has been completed, trained machine learning model(s) 232 can be provided to a computing device, if not already on the computing device. Inference phase 204 can begin after trained machine learning model(s) 232 are provided to computing device CD1.

During inference phase 204, trained machine learning model(s) 232 can receive input data 230 and generate and output one or more corresponding inferences and/or predictions 250 about input data 230. As such, input data 230 can be used as an input to trained machine learning model(s) 232 for providing corresponding inference(s) and/or prediction(s) 250 to kernel components and non-kernel components. For example, trained machine learning model(s) 232 can generate inference(s) and/or prediction(s) 250 in response to one or more inference/prediction requests 240. In some examples, trained machine learning model(s) 232 can be executed by a portion of other software. For example, trained machine learning model(s) 232 can be executed by an inference or prediction daemon to be readily available to provide inferences and/or predictions upon request. Input data 230 can include data from computing device CD1 executing trained machine learning model(s) 232 and/or input data from one or more computing devices other than CD1.

Input data 230 can include a collection of text strings provided by one or more sources. The collection of text strings can include natural language, artificially generated language, text from books, texts from online forums or chats, texts from emails, and/or other text. Other types of input data are possible as well.

Inference(s) and/or prediction(s) 250 can include output text strings, output token sequences, output sets of embedding vectors, numerical values, and/or other output data produced by trained machine learning model(s) 232 operating on input data 230 (and training data 210). In some examples, trained machine learning model(s) 232 can use output inference(s) and/or prediction(s) 250 as input feedback 260. Trained machine learning model(s) 232 can also rely on past inferences as inputs for generating new inferences.

### III. Example Systems

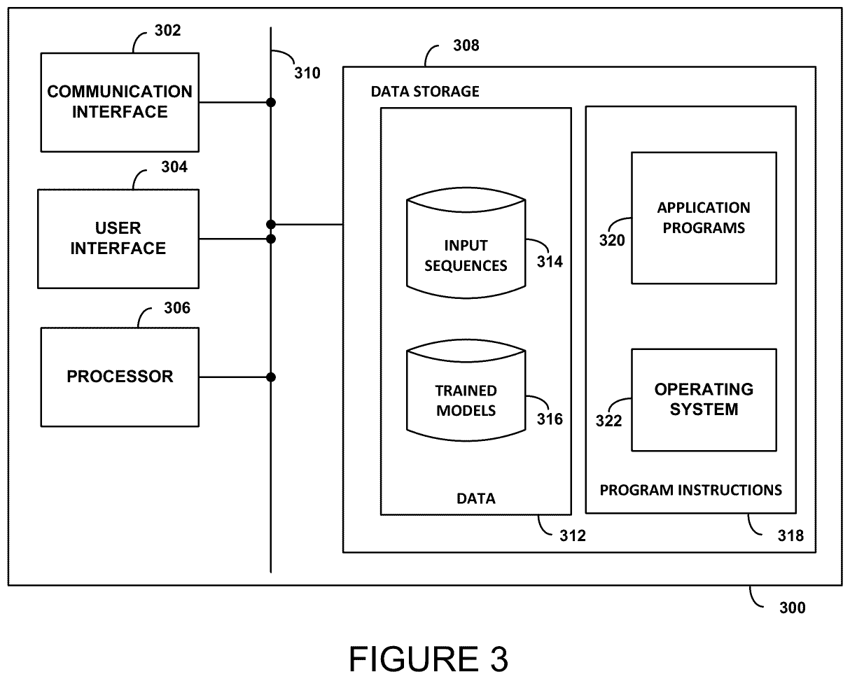

FIG. 3 illustrates an example computing device 300 that may be used to implement the methods described herein. By way of example and without limitation, computing device 300 may be a cellular mobile telephone (e.g., a smartphone), a computer (such as a desktop, notebook, tablet, or handheld computer, a server), elements of a cloud computing system, a robot, a drone, an autonomous vehicle, or some other type of device. It should be understood that computing device 300 may represent a physical computing device such as a server, a particular physical hardware platform on which a machine learning application operates in software, or other combinations of hardware and software that are configured to carry out machine learning functions as described herein.

As shown in FIG. 3, computing device 300 may include a communication interface 302, a user interface 304, a processor 306, and data storage 308, all of which may be communicatively linked together by a system bus, network, or other connection mechanism 310.

Communication interface 302 may function to allow computing device 300 to communicate, using analog or digital modulation of electric, magnetic, electromagnetic, optical, or other signals, with other devices, access networks, and/or transport networks. Thus, communication interface 302 may facilitate circuit-switched and/or packet-switched communication, such as plain old telephone service (POTS) communication and/or Internet protocol (IP) or other packetized communication. For instance, communication interface 302 may include a chipset and antenna arranged for wireless communication with a radio access network or an access point. Also, communication interface 302 may take the form of or include a wireline interface, such as an Ethernet, Universal Serial Bus (USB), or High-Definition Multimedia Interface (HDMI) port. Communication interface 302 may also take the form of or include a wireless interface, such as a Wifi, BLUETOOTH®, global positioning system (GPS), or wide-area wireless interface (e.g., WiMAX or 3GPP Long-Term Evolution (LTE)). However, other forms of physical layer interfaces and other types of standard or proprietary communication protocols may be used over communication interface 302. Furthermore, communication interface 302 may comprise multiple physical communication interfaces (e.g., a Wifi interface, a BLUETOOTH® interface, and a wide-area wireless interface).

In some embodiments, communication interface 302 may function to allow computing device 300 to communicate with other devices, remote servers, access networks, and/or transport networks. For example, the communication interface 302 may function to access one or more machine learning models and/or input therefor via communication with a remote server or other remote device or system in order to allow the computing device 300 to use the machine learning model to generate outputs (e.g., translated or otherwise transformed versions of inputs) based on input data. For example, the computing system 300 could be a translation server and the remote system could be a smartphone containing text (or input sound to be converted to text) to be applied to a machine learning model.

User interface 304 may function to allow computing device 300 to interact with a user, for example to receive input from and/or to provide output to the user. Thus, user interface 304 may include input components such as a keypad, keyboard, touch-sensitive or presence-sensitive panel, computer mouse, trackball, joystick, microphone, and so on. User interface 304 may also include one or more output components such as a display screen which, for example, may be combined with a presence-sensitive panel. The display screen may be based on CRT, LCD, and/or LED technologies, or other technologies now known or later developed. User interface 304 may also be configured to generate audible output(s), via a speaker, speaker jack, audio output port, audio output device, earphones, and/or other similar devices.

Processor 306 may comprise one or more general purpose processors—e.g., microprocessors—and/or one or more special purpose processors—e.g., digital signal processors (DSPs), graphics processing units (GPUs), floating point units (FPUs), network processors, tensor processing units (TPUs), or application-specific integrated circuits (ASICs). In some instances, special purpose processors may be capable of text processing, text tokenization, executing artificial neural networks, or executing convolutional neural networks, among other applications or functions. Data storage 308 may include one or more volatile and/or non-volatile storage components, such as magnetic, optical, flash, or organic storage, and may be integrated in whole or in part with processor 306. Data storage 308 may include removable and/or non-removable components.

Processor 306 may be capable of executing program instructions 318 (e.g., compiled or non-compiled program logic and/or machine code) stored in data storage 308 to carry out the various functions described herein. Therefore, data storage 308 may include a non-transitory computer-readable medium, having stored thereon program instructions that, upon execution by computing device 300, cause computing device 300 to carry out any of the methods, processes, or functions disclosed in this specification and/or the accompanying drawings. The execution of program instructions 318 by processor 306 may result in processor 306 using data 312.

By way of example, program instructions 318 may include an operating system 322 (e.g., an operating system kernel, device driver(s), and/or other modules) and one or more application programs 320 (e.g., functions for executing trained machine learning models) installed on computing device 300. Data 312 may include input sequences 314 (e.g., input text strings, input token sequences generated from text strings) and/or one or more trained machine learning models 316. Input sequences 314 may be used to train machine learning model and/or may be applied to such a trained model in order to generate translated text, output sets of vectors representing the input sequence in an embedding space, or some other model output as described herein.

Application programs 320 may communicate with operating system 322 through one or more application programming interfaces (APIs). These APIs may facilitate, for instance, application programs 320 reading and/or writing a trained machine learning model 316, transmitting or receiving information via communication interface 302, receiving and/or displaying information on user interface 304, and so on.

Application programs 320 may take the form of “apps” that could be downloadable to computing device 300 through one or more online application stores or application markets (via, e.g., the communication interface 302). However, application programs can also be installed on computing device 300 in other ways, such as via a web browser or through a physical interface (e.g., a USB port) of the computing device 300.

### IV. Example Methods

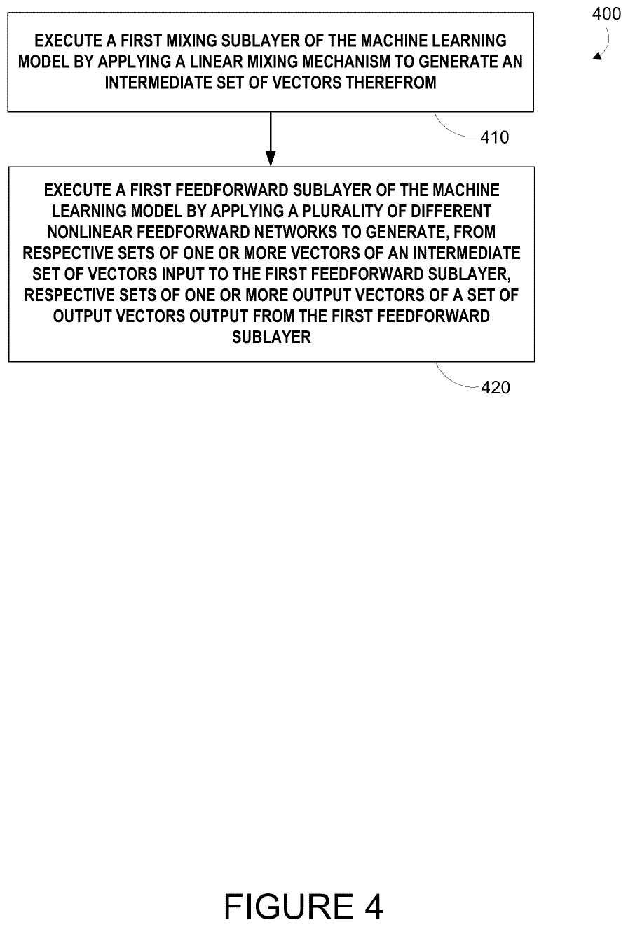

FIG. 4 is a flowchart of a method 400 for executing a machine learning model to generate an output from an input. The machine learning model includes a plurality of layers organized in order such that each layer of the plurality of layers receives as an input the output from a previous layer and/or provides an output to a subsequent layer as an input thereto. A given layer of the plurality of layers includes (i) a mixing sub-layer that receives an input set of vectors to the given layer and generates therefrom an intermediate set of vectors of the given layer and (ii) a feedforward sublayer that receives as an input the intermediate set of vectors of the given layer and generates therefrom an output set of vectors of the given layer.

The method 400 for executing the machine learning model includes executing a first mixing sublayer of the machine learning model by applying a linear mixing mechanism to generate an intermediate set of vectors therefrom (410). The method 400 additionally includes executing a first feedforward sublayer of the machine learning model by applying a plurality of different nonlinear feedforward networks to generate, from respective sets of one or more vectors of an intermediate set of vectors input to the first feedforward sublayer, respective sets of one or more output vectors of a set of output vectors output from the first feedforward sublayer (420). The method 400 could include additional or alternative steps or features.

### V. Experimental Results

To evaluate the machine learning model architectures described herein, the capacity of sparsely gated Mixture-of-Experts (MoE) was combined with the speed and stability of linear, mixing transformations to design and evaluate the “Sparse Mixer” encoder model. Sparse Mixer outperformed BERT on GLUE and SuperGLUE (with respect to accuracy) while training 65% faster and running inference 61% faster. A faster variant, named “Fast Sparse Mixer,” was also evaluated that marginally underperformed BERT on SuperGLUE (with respect to accuracy), but trained and ran nearly twice as fast. The design of these two models was improved by carefully ablating through various linear mixing mechanisms, MoE configurations, and model hyper parameters. Sparse Mixer overcame many of the latency and stability concerns of MoE models and can be employed as sparse ‘student models’ without resorting to distilling such student models to dense variants.

Sparsely gated Mixture-of-Experts (MoE) models offer the promise of sub linear compute costs with respect to the number of model parameters. By training “experts” that can independently process different slices of input data, MoE layers increase model capacity with limited increases in FLOPS.

MoE can be used to scale up large models. Using MoE layers to scale to larger models offers quality and total training efficiency gains over dense models, but does not provide benefits with respect to training or inference step latency. Indeed, the task of serving these models in practice has been generally ignored or relegated to distilling the sparse teacher model to a dense student model, often with a significant quality loss relative to the sparse teacher model. For example, this method was only able to distill roughly 30% of the Switch Transformer's quality gains to a dense model.

Efficient mixing models replace attention in Transformer-like models with simpler linear transformations or MLP blocks that “mix” input representations. Linear transformations are attractive because they are faster than the combined projection and dot product operations in an attention layer.

MoE and mixing elements were applied to build low latency, sparse encoder models that offer a variety of benefits in production settings. The experimental validations described herein focus on encoder models, in particular BERT-like models, because they are widely used in practice—for example, in dual encoders for retrieval.

Relative to the vanilla Transformer model, the improved models described herein were sped up in at least two ways. First, the increased capacity of MoE sublayers was used to offset parameter reductions in other parts of the model. Secondly, linear mixing transformations were used to replace a large fraction of self-attention sublayers with faster, linear transformations. The resulting model, which can be referred to as “Sparse Mixer,” slightly (<1%) outperforms BERT on GLUE and SuperGLUE validation tasks while training 65% faster and running inference 61% faster. A simple variant of Sparse Mixer, which can be referred to as “Fast Sparse Mixer,” is also provided that marginally (<0.2%) under performs BERT on SuperGLUE, but runs nearly twice as fast: training 89% faster and running inference 98% faster.

The models described herein exhibit a training stability synergy between the sparse and mixing model components. As a point of comparison, simply replacing dense feed-forward sub layers in BERT with MoE variants yields highly unstable models (discussed in greater detail below). However, these instabilities dissipate as self-attention sublayers are replaced with linear mixing sublayers. The (token-dependent) relevance weighted self-attention basis may be the source of the instability, and hence replacing the majority of self-attention sublayers with linear mixing sublayers can render the sparse mixer models described herein highly stable.

In summary, two models are provided herein and experimental validation data provided therefor: (i) Sparse Mixer, which matches BERT on GLUE and SuperGLUE but runs 61-65% faster; and (ii) Fast Sparse Mixer, which slightly underperforms BERT (<0.2%) but is nearly 2× faster.

The design of these models was evaluated by ablating through model mixing, MoE, and hyperparameter configurations. With Sparse Mixers, data is provided that demonstrates that the speed and stability costs of MoE models may be balanced or overcome using linear mixing mechanisms. This allows such sparse models to be served directly, rather than distilling them to dense variants.

Mixture-of Experts (MoE) models were introduced by Jacobs et al. (1991) and more recently popularized by Shazeer et al. (2017). Recent work in MoE models has achieved state of the art results on a number of NLP benchmarks. These recent models are large and primarily focus on model quality. When efficiency is studied, it is typically at the level of a total train time efficiency metric. For example, although the per training step speed of the Switch Transformer is slower than the vanilla Transformer, because the Switch Transformer surpasses the vanilla model's top accuracy in a fraction of the steps, the Switch Transformer can be correctly described as a more efficient model. However, the slower step speed is an Achilles heel for serving such models; one generally cannot ask a user to wait longer for a more accurate model response.

Memory mechanisms are another popular sparse technique for adding capacity to models with limited increases in compute. While intuitively appealing and empirically promising, suboptimal implementations (look-ups in particular) for accelerator hardware often yield memory models that have favorable theoretical compute properties, but are slow in practice.

Several recent works have explored mixing mechanisms, such as matrix multiplications, MLP blocks, and spectral transforms, as an efficient replacement of attention in Transformer-like models. Hybrid attention-mixing models, wherein partial or a limited number of attention sublayers are retained, were faster than Transformers with limited accuracy degradation.

Scaling up models has proven to be a successful program for increasing model quality. The relationship between the number of model parameters and model quality can be roughly modeled through a power law. However, the configuration of these parameters within the model also plays an important role in model quality and efficiency. The models described herein, when made thinner (smaller model dimensions) and deeper (more layers), generally exhibit more efficient distribution of parameters throughout the model for a given level of accuracy.

FIG. 1B depicts example Sparse Mixer encoder blocks for a ‘Base’ configuration thereof. Layer norms, residual connections, embedding layers and output layers are not shown. The top K=4 blocks contain self-attention and dense MLPs; the middle M=4 blocks contain linear mixing and sparse MLPs; and the remaining L=1 and P=5 blocks contain mixing and dense MLPs.

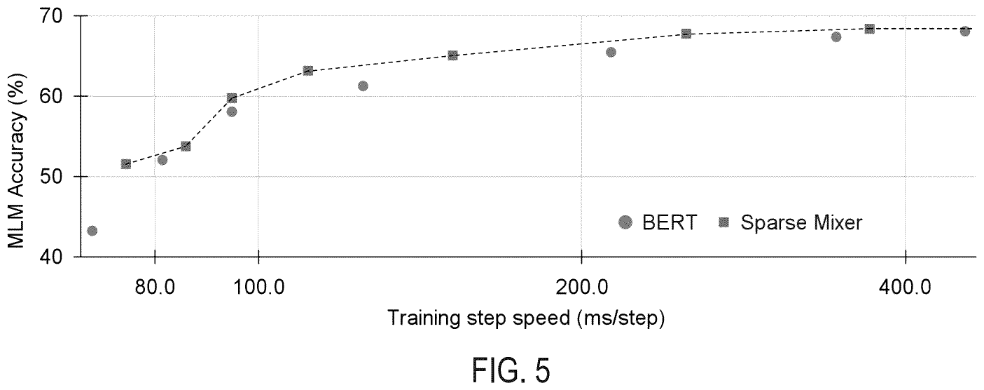

FIG. 5 depicts pre-training speed-accuracy trade-offs for Sparse Mixer and BERT. The dashed line shows the Pareto efficiency frontier, indicating the best trade-offs. All models were trained on 32 TPU v3 chips. To better utilize the increased number of devices, a larger batch size of 256 was used but trained for fewer (250k) steps. As FIG. 5 shows, speed-ups and quality gains from Sparse Mixer carry over to both larger (teacher) and smaller (student) sizes.

The design space investigated for the Sparse Mixer builds off of the stacked encoder blocks of BERT (Devlin et al., 2019), which were used as an example of the canonical Transformer encoder (Vaswani et al., 2017). Each encoder block contains a linear mixing or self-attention sublayer and a (dense or MoE) MLP sublayer, connected with residual connections and layer norms. The standard BERT input embedding and output projection layers were also used. The Sparse Mixer encoder block stack, shown in FIG. 1B, was selected by carefully ablating through mixing mechanisms, MoE configurations, and model hyperparameters, as described below.

In an MoE layer, multiple, different instances (“experts”) of the layer were initialized and performed parallel computations with each instance over separate data shards. The sparsely activated MoE layers therefore had greater capacity than dense layers. The number of experts was increased, the expert capacity—the number of tokens processed by an individual expert—was typically decreased. To be specific, with E denoting the number of experts and n the number of tokens, we set

$$expert capacity = cf \times n / E ,$$

where cf is the scalar capacity factor. For cf≈1, this allows model parameter count to be increased with minimal increases in FLOPS.

A router or gating function was used to direct data shards between experts. This follows the intuition that expert A may become specialized at processing inputs in one part of the embedding space, while experts B, C, . . . may become specialized to other parts of the embedding space. It is the router that ensures sparsity by assigning only a subset of tokens to each expert, thereby ensuring that only a subset of parameters are activated for each token.

Router design is an active research area. The work described herein implemented and evaluated two router types: traditional “Tokens Choose” and “Experts Choose.” Routing was performed at the token level—the router assigned each token to a subset of experts. Both assignment algorithms first generate router logits by projecting token representations from the embedding dimension, dₘ, to the expert dimension, E. A softmax was applied to normalize the logits to a probability distribution. Finally, tokens were assigned to experts using one of the assignment algorithms.

Tokens Choose routing. For Tokens Choose routing, each token was assigned to its top-k experts. Top-1 (“Switch”) routing was implemented as evaluated. Because expert capacities are limited, there is no guarantee that a given token can be routed to its top expert, although any token that fails to reach an expert will still propagate into the next encoder block through the residual connection. There is also no guarantee that a given expert receives at least one token. So, to ensure that compute is efficiently distributed among experts, a load balancing loss was included.

Expert capacity can be increased by increasing the capacity factor, cf. This will increase the probability that a given token is routed to its desired experts. Decreasing cf will further sparsify the model and speed up the MoE sublayer. Batch Prioritized Routing was used to prioritize routing tokens with the highest router probability, rather than simply routing tokens in left-to-right ordering or some other default ordering in the batch.

Experts Choose routing. For the Experts Choose assignment algorithm, experts choose their top tokens, rather than tokens choosing experts. This effectively amounts to a transpose of the router probabilities prior to the top-k operation. Each expert performs its top-k operation with k=expert capacity. An individual token may be processed by multiple experts or none at all. Because experts have their choice of tokens and always fill their buffer, increasing the capacity factor, cf, will increase both the number of tokens that an expert processes and also the number of experts to which a given token is routed. Because each expert always fills its capacity, no auxiliary loading balancing loss is required.

Tokens were subdivided into groups and expert assignment was performed on a per-group basis. A larger group size will result in slower but more accurate top-k and sorting computations, whereas a smaller group size will result in faster but more approximate routing choices. In practice, it was found that imperfect routing choices were tolerable and a default group size of 4096 tokens was used.

In this work, faster, servable architectures using expert and data parallelism were investigated. Data parallelism was used to shard data across devices, and expert parallelism was used to partition experts across devices; for example, placing experts 1 and 2 on device 1, experts 3 and 4 on device 2, and so on. Model parallelism is a third axis to shard model weights (matrices) across devices; for example, expert 1 is split across devices 1 and 2, expert 2 is split across devices 3 and 4, and so on. Model parallelism is typically most beneficial for scaling to larger model sizes.

Simple linear mixing transformations were used as drop-in replacements for a subset of the self-attention sublayers. Linear mixing transformations trade increased speed for reduced capacity and flexibility. Indeed, the attention mechanism contains four parameterized projections and two dot product operations (“QK” and “V ”), allowing self-attention sublayers to construct representations in a highly expressive, token-dependent basis. On the other hand, the mixing transformations investigated herein were implemented through two token-independent projections, one along each of the sequence and model dimensions. Fixing the mixing basis, relative to different data inputs, stabilizes the model.

The Fourier and Hartley transforms were also investigated as linear mixing mechanisms. These transforms were investigated through a Fourier sublayer. The Fourier sublayer applied a 1D Discrete Fourier Transform (DFT) along the sequence dimension, F_{seq}, and a 1D DFT along the hidden dimension, Fₕ:

$$y = ( {F}_{seq} ( {F}_{h} ( x ) ) ) , \qquad ( 1 )$$

where [symbol] denotes the real part.

The Hartley sublayer used Equation (1) with the DFT replaced with the Discrete Hartley Transform, H. The Fourier and Hartley transforms were computed using the Fast Fourier Transform (FFT).

In Equation (1), transforms are performed along both the sequence and hidden dimensions. Although the primary purpose of a linear mixing sublayer is to combine inputs along the sequence dimension, it is known that also mixing along the hidden dimension improves model quality.

Structured matrices were also investigated under the hypothesis that adding structure to the mixing basis may improve the distribution of output representations. Two parameterized, structured matrices were considered: Toeplitz and circulant. A Toeplitz matrix is a matrix in which each diagonal is constant. A circulant matrix is a particular kind of Toeplitz matrix, in which all rows are composed of the same elements but rotated one element to the right relative to the preceding row. For both matrices, the weights are learned. The corresponding linear mixing sublayer mixed along the sequence and hidden dimension. For example, for the Toeplitz case:

$$y = {T}_{seq} {T}_{h} x , \qquad ( 2 )$$

where T_{seq} and Tₕ denote Toeplitz matrices.

“Unstructured”, fully dense parameterized matrix projections were also evaluated. The linear mixing sublayer arising from this case can be called the “Linear” sublayer. The Linear sublayer performs the same FLOPS as the structured matrix sublayers (provided the FFT is not used), but is more flexible due to the increased number of matrix weights

The models described herein were trained and optimized on 8 V100 GPUs. The results provided herein are reasonably robust to differing accelerators (e.g. TPU) as almost all of the applied modifications represent accelerator friendly matrix multiplications. Model sizes were scaled up and down on TPUs, finding that similar favorable efficiency trade-offs persist. JAX in the Flax framework was used.

Training was performed in a typical transfer learning setting: Masked Language Modelling (MLM) and Next Sentence Prediction (NSP) pre training, followed by fine-tuning on GLUE and SuperGLUE. When comparing models, the exact same setup was used for all models and baselines. In particular, the pre-training setup of (Devlin et al., 2019) was used with a few modification: (1) pre training was performed on the much larger C4dataset; (2) a 32000 SentencePiece vocabulary model trained on a 100 million sentence subset of C4 was used; and (3) a smaller batch size of 64 was used. A sequence length of 512 was used throughout pre-training. Experiments were run on 8 V100 GPU chips, except for the scaling experiments which were run on 32 TPU v3 chips.

The various model configurations described herein will be described via a process of “coordinate descent” until arriving at the final Sparse Mixer design. Given the large number of model hyperparameters to explore, multiple parameter searches were performed in parallel. For example, the model shape and MoE configurations were explored independently and then the most promising configurations from each program were combined

TABLE 1
Average accuracy metrics and median pretraining step speeds for linear
mixing models. The “Fourier” model was identical to FNet.
Speed-ups relative to BERT (see Table 8) are shown in parentheses.
The best metrics are highlighted in boldface, while the second best
metrics are underlined. Stars indicate the ‘selected’ configurations.

| | Accuracy (%) | | | Speed |
|---|---|---|---|---|
| Model | GLUE | MLM | NSP | (ms/batch) |
| Fourier | 78.4 | 55.7 | 75.4 | 173 (1.75×) |
| Hartley * | 78.0 | 58.5 | 74.9 | 172 (1.77×) |
| Circulant | 75.1 | 58.3 | 75.6 | 200 (1.52×) |
| Toeplitz | 76.5 | 57.7 | 76.5 | 200 (1.52×) |
| Linear * | 77.7 | 57.6 | 77.4 | 200 (1.52×) |

For the coordinate descent study, pre training was only performed for 500k steps, which was found to be reasonably indicative of model performance. Models were fine-tuned with the same batch size (64) on the Validation split of each respective GLUE task for 5 epochs and the best result for each task was selected from across three default base learning rates: {10⁻⁵, 5·10⁻⁵, 10⁻⁴}. The final model was pre trained for longer and was evaluated on both GLUE and SuperGLUE for a broader set of training configurations.

Efficiency—speed and accuracy—was prioritized. Pre-training step speed was used as a proxy for model latency. Downstream average GLUE scores were used as the primary accuracy metric, upstream MLM and NSP accuracies were used as fallbacks when GLUE scores between model variants were similar.

The linear mixing mechanisms discussed above were evaluated. For each linear mixing model, all self-attention sublayers were first replaced with the corresponding mixing sublayer. The results are shown in Table 1. The spectral models (Fourier and Hartley) performed the best on GLUE. The linear model slightly under-performed the spectral models, while the structured mixing models (Circulant and Toeplitz) performed worst on GLUE. The spectral methods, efficiently implemented using FFTs, were the fastest.

TABLE 2
Metrics for hybrid attention-mixing models. Hartley-k denotes a model
with k self-attention sublayers and 12 - k Hartley sublayers.

| | Accuracy (%) | | | Speed |
|---|---|---|---|---|
| Model | GLUE | MLM | NSP | (ms/batch) |
| Hartley-0 | 78.0 | 58.5 | 74.9 | 172 (1.76×) |
| Hartley-1 | 78.0 | 51.9 | 75.3 | 183 (1.66×) |
| Hartley-2 | 81.1 | 61.3 | 79.8 | 193 (1.57×) |
| Hartley-3 | 77.9 | 50.3 | 76 | 204 (1.49×) |
| Hartley-4 | 82.7 | 62.6 | 81 | 216 (1.41×) |
| Hartley-6 | 82.9 | 63.5 | 81.2 | 234 (1.30×) |
| Linear-0 | 77.7 | 57.6 | 77.4 | 200 (1.51×) |
| Linear-1 | 78.1 | 62.5 | 78.3 | 208 (1.46×) |
| Linear-2 | 82.8 | 62.8 | 81 | 218 (1.40×) |
| Linear-3 | 82.8 | 63.3 | 81.6 | 226 (1.35×) |
| Linear-4 * | 83.4 | 63.6 | 81.7 | 235 (1.29×) |
| Linear 6 | 83.6 | 64 | 81.7 | 251 (1.21×) |

Two strong representative candidates were chosen from Table 1, namely the Hartley and Linear models, and a subset of the topmost mixing sublayers were replaced with self-attention. The results are summarized in Table 2.

Once self-attention was included, the hybrid Linear model offered larger quality gains than the hybrid Hartley model. Even though the hybrid Hartley models were faster, an iso-speed comparison still suggests that the hybrid Linear models were more efficient. For example, Hartley-6 and Linear 4 had roughly the same speed, but the Linear-4 model is more accurate. Hence, the Linear-4 model was chosen.

All model shape experiments were run in parallel and started from the Linear-4 configuration.

In seeking a more efficient model, attempts were made to slim the model down both by decreasing the model dimension (Table 3) and the intermediate MLP activation dimension. For each coordinate, it was found that there were cutoffs (d_{ff}=2048 and dₘ=512) below which model quality dropped drastically. These cutoffs were selected as the optimal model shape values. It is in decreasing these two hyperparameters that the biggest speed-up in the model was obtained. However, there was a material degradation in quality that can be compensated for by the increased capacity from the MoE sublayers.

The number of layers was also varied and evaluated. 14 layers was selected, beyond which quality gains were not observed.

TABLE 3
Varying the model dimension, dₘ. As in the Transformer,
the model and embedding dimension were set to be
equal. For the self-attention sublayers, the number of self-attention
heads was fixed to dₘ/64.

| | Accuracy (%) | | | Speed |
|---|---|---|---|---|
| dₘ | GLUE | MLM | NSP | (ms/batch) |
| 768 | 83.4 | 63.6 | 81.7 | 235 (1.29×) |
| 512 * | 83.0 | 62.5 | 80.9 | 161 (1.89×) |
| 256 | 80.7 | 58.9 | 78.4 | 91 (3.34×) |
| 128 | 71.6 | 54 | 73.8 | 58 (5.29×) |

TABLE 4
Accuracy and speed metrics for Top-1 Tokens
Choose (TC) and Experts Choose (EC) routing.

| | Accuracy (%) | | | Speed |
|---|---|---|---|---|
| Router | GLUE | MLM | NSP | (ms/batch) |
| TC | 83.4 | 64 | 80.8 | 280 (1.09×) |
| EC * | 83.5 | 64.6 | 81.2 | 283 (1.08×) |

The starting configuration for the MoE ablation evaluations was the Linear-4 configuration with every other dense MLP sublayer replaced by an MoE sublayer (6 MoE sublayers) and 16 experts in each MoE sub layer. The MoE experiments were performed in parallel to the model shape optimizations, so all MoE ablations were performed on a default ‘Base’ sized model with 12 layers, d_{ff}=3072 and dₘ=768.

It was found that the fine-tuning learning protocol can be adjusted to better transfer any MoE MLM pre-training gains downstream. In particular, the MoE encoder models benefitted from larger base learning rates ({10⁻⁴, 5·10⁻⁴, 10⁻³}) and larger dropout rates (0.2) for experts. For the final model comparison with BERT, a wide range of base learning rates were considered for all models.

TABLE 5
Varying the number and layout of MoE sub layers. Layout definition:
6-BOTTOM (first 6 layers), 6-MIDDLE (middle 6 layers) or
6-MIXED (every odd layer), 6-MIXED-odd (every even layer),
and 6-TOP (final 6 layers). The number of experts and the
expert capacity - the number of tokens processed by each
expert - was fixed. Each MoE layer added some compute and
device communication overhead, slowing the model.

| | Accuracy (%) | | | Speed |
|---|---|---|---|---|
| Config | GLUE | MLM | NSP | (ms/batch) |
| 2-MIXED | 83.6 | 63.6 | 81.3 | 246 (1.23×) |
| 4-MIXED * | 83.6 | 63.9 | 81.3 | 264 (1.15×) |
| 6-MIXED | 83.5 | 64.6 | 81.2 | 283 (1.08×) |
| 12-MIXED | 83.1 | 64.9 | 81.4 | 352 (0.86×) |
| 6-BOTTOM | 83.2 | 62.7 | 81.4 | 289 (1.05×) |
| 6-MIDDLE * | 83.9 | 64 | 81.7 | 284 (1.08×) |
| 6-MIXED | 83.5 | 64.6 | 81.2 | 283 (1.08×) |
| 6-MIXED-odd | 83.2 | 64.8 | 81.6 | 292 (1.04×) |
| 6-TOP | 83.4 | 65.4 | 81.2 | 287 (1.06×) |

Routing mechanisms are compared in Table 4. Experts Choose routing was selected as it obtains slightly higher accuracy results and does not require configuring a load balancing loss.

In Table 5, the number of MoE sublayers and the layout of those layers within the model were varied. As the number of MoE layers increased, MLM accuracy improved, but these pre training gains did not always lead to better GLUE performance. For 4 MoE layers was selected, which performed well on GLUE and better than the 2 MoE sublayer model on the MLM task.

The results of MoE layout experiments were clearer—the MIDDLE layout was selected, placing all of the MoE sublayers in the middle layers of the model. Nevertheless, it is interesting to note that the TOP layout gave a big boost to MLM accuracy, but did not improve downstream GLUE accuracy.

The number of experts can be increased to increase the capacity of the model. For a large number of experts, the computational cost of the routing assignment is more significant, while the training signal to an individual expert becomes too weak to facilitate effective training as each expert processes too small a slice of data. Seeking a compromise between quality and speed, 16 experts was selected.

The number of parameters in each expert can be controlled by varying its d_{ff}. It was found that: (1) using smaller experts yielded a small accuracy drop, but limited speed benefits; and (2) increasing expert size increased MLM accuracy, but not GLUE. So, for simplicity, the expert d_{ff} was kept the same size as the dense d_{ff}.

The preceding results, taken together, result in the Sparse Mixer model depicted in FIG. 1B:
Shape: 14 layers, 512 dₘ, 2056 d_{ff};
Sparse: 4 MIDDLE MoE, 16 experts, 2056 d_{ff}, EC routing, 1.0 cf;
Mixer: Linear, 4 TOP Attention layers.

When comparing Sparse Mixer and BERT, both models were pre-trained on C4 for the full 1M steps, with batch size 64, and then evaluated on both GLUE and SuperGLUE for a larger range of fine-tuning batch sizes (16, 32, and 64) and base learning rates ({10⁻⁵, 5·10⁻⁵, 10⁻⁴, 5·10⁻⁴, 10⁻³}). The best results across all learning rates (for each task) and batch sizes (for all tasks) are shown in Tables 6 and 7.

BERT and Sparse Mixer's GLUE scores were very similar, although they diverged more on SuperGLUE, where Sparse Mixer performed particularly well on the CB task, but underperformed BERT on the multi-label MultiRC and ReCoRD tasks.

Tables 6-8 indicate that the Sparse Mixer was more efficient than BERT in the Base configuration. In FIG. 5, BERT and Sparse Mixer are compared across a selection of model sizes. MLM accuracy was used as a proxy for model accuracy and pre-training step speed was used as a proxy for overall model speed. Pre-training step speed is a good proxy for inference speed (see Table 8). MLM accuracy was only indicative of downstream accuracy. FIG. 5 suggests that Sparse Mixer's favorable speed and accuracy extend to other model sizes, as it defines the efficiency frontier across all model sizes considered.

TABLE 6
GLUE results on the Validation split. F1/accuracy scores are reported
for QQP and MRPC, Spearman correlations for STS-B, and accuracy scores for all other tasks.
The MNLI accuracy metrics are reported by the match/mismatch splits.

| Model | MNLI | QQP | QNLI | SST-2 | CoLA | STS-B | MRPC | RTE | Avg. |
|---|---|---|---|---|---|---|---|---|---|
| BERT | 81.3/81.8 | 86.7/90.3 | 88.9 | 91.1 | 77.6 | 87.3 | 90.5/86.8 | 69.7 | 84.7 |
| Sparse Mixer | 80.7/81 | 87.1/90.5 | 89.1 | 90.9 | 79 | 88.1 | 90.4/86.3 | 72.2 | 85.0 |

TABLE 7
SuperGLUE Validation results. Macro-F1 scores are reported for CB,
micro-F1/exact match scores for MultiRC, Fl/exact match scores for ReCoRD, and accuracy
scores for all other tasks.

| Model | BoolQ | CB | COPA | MultiRC | ReCoRD | RTE | WiC | Avg. |
|---|---|---|---|---|---|---|---|---|
| BERT | 74.6 | 86.4/85.7 | 58 | 74.1/26.2 | 68.6/52.2 | 65 | 65.7 | 65.7 |
| Sparse Mixer | 74.4 | 93.3/92.9 | 62 | 72.4/22.5 | 65.9/49.2 | 64.6 | 66.5 | 66.4 |

TABLE 8
Model computational characteristics for BERT, Sparse Mixer
(SM) and Fast Sparse Mixer (FSM). “Size” is the
number of model parameters. Run speeds were measured by
inference speed per example and pre-training step speed per example.

| | GFLOPS | Size | Inference | Training |
|---|---|---|---|---|
| Model | (/ex) | (M) | (ms/ex) | (ms/ex) |
| BERT | 102 | 112 | 1.34 | 4.75 |
| SM | 73 | 180 | 0.84 (1.61×) | 2.87 (1.65×) |
| FSM | 60 | 180 | 0.68 (1.98×) | 2.51 (1.89×) |

TABLE 9
Fast Sparse Mixer (FSM). The default Sparse Mixer (SM) uses
a capacity factor (cf) of 1 and a routing group size (g) of
4096. Several less favorable configurations are omitted.

| | Accuracy (%) | | Speed |
|---|---|---|---|
| Model | GLUE | SuperGLUE | (ms/batch) |
| BERT | 84.7 | 65.7 | 304 |
| SM | 85.0 | 66.4 | 184 (1.65×) |
| FSM (cf = 0.5) | 84.7 | 65.6 | 161 (1.89×) |
| g = 2048 | 84.5 | 65.1 | 173 (1.75×) |
| cf = 0.75, g = 2048 | 84.3 | 65.2 | 165 (1.84×) |

TABLE 10
Stability of BERT, sparse BERTs and Sparse Mixer (SM). BERT-k
denotes a BERT model with k MoE layers. The “unstable”
runs experienced gradient blow-up and failed to converge to an
optimal loss (or to converge at all). Batch sizes of 64 and 256
were used. Accuracy and speed metrics are reported for 64 batch runs.

| | Stable | | Accuracy (%) | | Speed |
|---|---|---|---|---|---|
| Model | 64 | 256 | GLUE | S. GLUE | (ms/batch) |
| BERT | 3/4 | 4/4 | 84.7 | 65.7 | 304 |
| SM | 4/4 | 4/4 | 85.0 | 66.4 | 184 (1.65×) |
| BERT-4 | 0/4 | 0/4 | — | — | — |
| BERT-12 | 1/4 | 0/4 | 84.1 | 60.9 | 426 (0.71×) |

An even sparser model was designed by decreasing the expert capacity factor. This decreases the number of tokens that each expert processes and yielded significant speed-ups for a limited quality degradation: for a minor (0.2%) accuracy drop on SuperGLUE relative to BERT, a Sparse Mixer with capacity factor of 0.5 trains 89% faster and runs inference 98% faster; see Table 8. This variant of the model can be referred to as “Fast Sparse Mixer.” Decreasing the token routing group size was also evaluated, but this led to larger quality drops.

Table 10 compares the stability of Sparse Mixer, BERT and “sparse BERTs”—MoE variants of BERT. Sparse Mixer was very stable, even relative to (dense) BERT. The sparse BERTs were highly unstable, with only one stable run that ultimately yielded a slow model that significantly underperformed BERT. The Sparse Mixer's improved stability may be due to replacing most of the self-attention sublayers with linear mixing, which constrains the model to a less variable mixing basis.

Mixing transformations and MoE, when combined as described herein, result in unexpected benefits beyond the ‘sum of their parts.’ Combining MoE (for capacity) and mixing (for speed and stability) results in the Sparse Mixer model described herein—a model that outperforms BERT on GLUE and SuperGLUE, while training 65% faster and running inference 61% faster. A faster variant, Fast Sparse Mixer, is also provided herein that marginally under performs BERT on Super GLUE, but that trains and runs nearly twice as fast: 89% faster training and 98% faster inference. Sparse Mixer overcomes many of the speed and stability concerns of MoE models and offers the prospect of being used to serve sparse student models.

The models and evaluations described herein focus on BERT-like encoder models, since such models find extremely wide use. Sparse mixer encoder-decoder and decoder-only models are, in principle, straightforward extensions: Linear decoders can be designed by “causally” masking the Linear matrix and encoder-decoder mixing can also be designed with careful masking.

### VI. Conclusion

The above detailed description describes various features and functions of the disclosed systems, devices, and methods with reference to the accompanying figures. In the figures, similar symbols typically identify similar components, unless the context indicates otherwise. The illustrative embodiments described in the detailed description, figures, and claims are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the message flow diagrams, scenarios, and flowcharts in the figures and as discussed herein, each step, block and/or communication may represent a processing of information and/or a transmission of information in accordance with example embodiments. Alternative embodiments are included within the scope of these example embodiments. In these alternative embodiments, for example, functions described as steps, blocks, transmissions, communications, requests, responses, and/or messages may be executed out of order from that shown or discussed, including in substantially concurrent or in reverse order, depending on the functionality involved. Further, more or fewer steps, blocks and/or functions may be used with any of the message flow diagrams, scenarios, and flow charts discussed herein, and these message flow diagrams, scenarios, and flow charts may be combined with one another, in part or in whole.

A step or block that represents a processing of information may correspond to circuitry that can be configured to perform the specific logical functions of a herein-described method or technique. Alternatively or additionally, a step or block that represents a processing of information may correspond to a module, a segment, or a portion of program code (including related data). The program code may include one or more instructions executable by a processor for implementing specific logical functions or actions in the method or technique. The program code and/or related data may be stored on any type of computer-readable medium, such as a storage device, including a disk drive, a hard drive, or other storage media.

The computer-readable medium may also include non-transitory computer-readable media such as computer-readable media that stores data for short periods of time like register memory, processor cache, and/or random access memory (RAM). The computer-readable media may also include non-transitory computer-readable media that stores program code and/or data for longer periods of time, such as secondary or persistent long term storage, like read only memory (ROM), optical or magnetic disks, and/or compact-disc read only memory (CD-ROM), for example. The computer-readable media may also be any other volatile or non-volatile storage systems. A computer-readable medium may be considered a computer-readable storage medium, for example, or a tangible storage device.

Moreover, a step or block that represents one or more information transmissions may correspond to information transmissions between software and/or hardware modules in the same physical device. However, other information transmissions may be between software modules and/or hardware modules in different physical devices.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

We claim:

1. A method comprising:
executing a machine learning model to generate an output from an input, wherein the machine learning model comprises a plurality of layers organized in order such that each layer of the plurality of layers receives as an input the output from a previous layer and/or provides an output to a subsequent layer as an input thereto, wherein a given layer of the plurality of layers comprises (i) a mixing sub-layer that receives an input set of vectors to the given layer and generates therefrom an intermediate set of vectors of the given layer and (ii) a feedforward sublayer that receives as an input the intermediate set of vectors of the given layer and generates therefrom an output set of vectors of the given layer, wherein executing the machine learning model comprises:
executing a first mixing sublayer of the machine learning model by applying a linear mixing mechanism to generate an intermediate set of vectors therefrom; and
executing a first feedforward sublayer of the machine learning model by applying a plurality of different nonlinear feedforward networks to generate, from respective sets of one or more vectors of an intermediate set of vectors input to the first feedforward sublayer, respective sets of one or more output vectors of a set of output vectors output from the first feedforward sublayer.

2. The method of claim 1, wherein executing the first mixing sublayer by applying a linear mixing mechanism to generate an intermediate set of vectors therefrom comprises multiplying an input to the first mixing sublayer with a first matrix.

3. The method of claim 2, wherein multiplying the input to the first mixing sublayer with the first matrix comprises pre-multiplying the input to the first mixing sublayer by the first matrix, and wherein executing the first mixing sublayer additionally comprises post-multiplying the product of the first matrix and the input to the first mixing sublayer by a second matrix.

4. The method of claim 1, wherein executing the machine learning model comprises executing a second feedforward sublayer of the machine learning model by applying a single nonlinear feedforward network to generate, from each vector of an intermediate set of vectors input to the second feedforward sublayer, respective output vectors of a set of output vectors output from the second feedforward sublayer.

5. The method of claim 1, wherein executing the first feedforward sublayer of the machine learning model comprises executing a router to assign each of the sets of one or more vectors of the intermediate set of vectors input to the first feedforward sublayer to a respective nonlinear feedforward network of the plurality of different nonlinear feedforward networks.

6. The method of claim 5, wherein executing the router comprises determining, for each vector of the intermediate set of vectors input to the first feedforward sublayer, a respective destination network of the plurality of different nonlinear feedforward networks which is applied thereto.

7. The method of claim 5, wherein executing the router comprises determining, for each network of the plurality of different nonlinear feedforward networks, at least one target vector to which the network is applied.

8. The method of claim 7, wherein a ratio of the total number vectors of the intermediate set of vectors to a number of vectors routed to each network of the plurality of different nonlinear feedforward networks is such that the plurality of different nonlinear feedforward networks is applied to fewer than all of the vectors of the intermediate set of vectors.

9. The method of claim 1, wherein executing the machine learning model further comprises:
executing a second mixing sublayer of a terminal layer of the plurality of layers by applying a self-attention mechanism to generate an intermediate set of vectors therefrom.

10. The method of claim 9, wherein executing the second mixing sublayer of the terminal layer of the plurality of layers by applying the self-attention mechanism to generate the intermediate set of vectors therefrom comprises:
generating, from a set of input vectors input to the second mixing layer, (i) a set of key vectors by multiplying the set of input vectors by a key matrix, and (ii) a set of query vectors by multiplying the set of input vectors by a query matrix;
multiplying the set of key vectors by the set of query vectors;
scaling the products of the set of the key vectors and the set of query vectors;
applying a softmax function to the scaled products of the set of the key vectors and the set of query vectors; and
multiplying the set of input vectors input to the second mixing layer by the set of outputs of the softmax function.

11. The method of claim 9, wherein the first feedforward sublayer is part of a middle layer of the plurality of layers, and wherein executing the machine learning model additionally comprises:
executing a second feedforward sublayer of the terminal layer by applying a single nonlinear feedforward network to generate, from each vector of the intermediate set of vectors generated from the second mixing sublayer, respective output vectors of a set of output vectors output from the second feedforward sublayer; and
executing a third feedforward sublayer of an initial layer of the plurality of layers by applying a single nonlinear feedforward network to generate, from each vector of an intermediate set of vectors input to the third feedforward sublayer, respective output vectors of a set of output vectors output from the third feedforward sublayer.

12. The method of claim 11, wherein executing the first feedforward sublayer of the machine learning model comprises executing a router to assign each of the sets of one or more vectors of the intermediate set of vectors input to the first feedforward sublayer to a respective nonlinear feedforward network of the plurality of different nonlinear feedforward networks.

13. The method of claim 1, wherein the first feedforward sublayer is part of a middle layer of the plurality of layers, wherein executing the machine learning model additionally comprises:
executing a second feedforward sublayer of a terminal layer of the plurality of layers by applying a single nonlinear feedforward network to generate, from each vector of an intermediate set of vectors input to the second feedforward sublayer, respective output vectors of a set of output vectors output from the second feedforward sublayer; and
executing a third feedforward sublayer of an initial layer of the plurality of layers by applying a single nonlinear feedforward network to generate, from each vector of an intermediate set of vectors input to the third feedforward sublayer, respective output vectors of a set of output vectors output from the third feedforward sublayer.

14. The method of claim 13, wherein executing the first feedforward sublayer of the machine learning model comprises executing a router to assign each of the sets of one or more vectors of the intermediate set of vectors input to the first feedforward sublayer to a respective nonlinear feedforward network of the plurality of different nonlinear feedforward networks.

15. The method of claim 1, wherein the plurality of layers of the model comprises at least 14 layers and wherein a length of input vectors to any of the layers of the model is less than or equal to 512, and wherein a length of output vectors from any of the layers of the model is less than or equal to 512.

16. The method of claim 1, wherein the input to the machine learning model comprises a sequence of tokens, and wherein executing the machine learning model further comprises:
generating, as an input to a first layer of the plurality of layers of the machine learning model, a set of input vectors by mapping each token of the sequence of tokens to a respective embedding vector in the set of input vectors.

17. A method comprising:
training a machine learning model to generate an output from an input, wherein the machine learning model comprises a plurality of layers organized in order such that each layer of the plurality of layers receives as an input the output from a previous layer and/or provides an output to a subsequent layer as an input thereto, wherein a given layer of the plurality of layers comprises (i) a mixing sub-layer that receives an input set of vectors to the given layer and generates therefrom an intermediate set of vectors of the given layer and (ii) a feedforward sublayer that receives as an input the intermediate set of vectors of the given layer and generates therefrom an output set of vectors of the given layer, wherein a first mixing sublayer of the machine learning model uses a linear mixing mechanism to generate an intermediate set of vectors therefrom, and wherein a first feedforward sublayer of the machine learning model uses a plurality of different nonlinear feedforward networks to generate, from respective sets of one or more vectors of an intermediate set of vectors input to the first feedforward sublayer, respective sets of one or more output vectors.

18. The method of claim 17, wherein the first feedforward sublayer is part of a middle layer of the plurality of layers, wherein a second mixing sublayer of a terminal layer of the plurality of layers uses a self-attention mechanism to generate an intermediate set of vectors therefrom, wherein a second feedforward sublayer of the terminal layer uses a single nonlinear feedforward network to generate, from each vector of the intermediate set of vectors generated from the second mixing sublayer, respective output vectors of a set of output vectors output from the second feedforward sublayer, and wherein a third feedforward sublayer of an initial layer of the plurality of layers uses a single nonlinear feedforward network to generate, from each vector of an intermediate set of vectors input to the third feedforward sublayer, respective output vectors of a set of output vectors output from the third feedforward sublayer.

19. A non-transitory computer readable medium comprising program instructions executable by at least one processor to cause the at least one processor to perform a method comprising:
executing a machine learning model to generate an output from an input, wherein the machine learning model comprises a plurality of layers organized in order such that each layer of the plurality of layers receives as an input the output from a previous layer and/or provides an output to a subsequent layer as an input thereto, wherein a given layer of the plurality of layers comprises (i) a mixing sub-layer that receives an input set of vectors to the given layer and generates therefrom an intermediate set of vectors of the given layer and (ii) a feedforward sublayer that receives as an input the intermediate set of vectors of the given layer and generates therefrom an output set of vectors of the given layer, wherein executing the machine learning model comprises:
executing a first mixing sublayer of the machine learning model by applying a linear mixing mechanism to generate an intermediate set of vectors therefrom; and
executing a first feedforward sublayer of the machine learning model by applying a plurality of different nonlinear feedforward networks to generate, from respective sets of one or more vectors of an intermediate set of vectors input to the first feedforward sublayer, respective sets of one or more output vectors.

20. The non-transitory computer readable medium of claim 19, wherein the first feedforward sublayer is part of a middle layer of the plurality of layers, and wherein executing the machine learning model additionally comprises:
executing a second mixing sublayer of a terminal layer of the plurality of layers by applying a self-attention mechanism to generate an intermediate set of vectors therefrom;
executing a second feedforward sublayer of the terminal layer by applying a single nonlinear feedforward network to generate, from each vector of the intermediate set of vectors generated from the second mixing sublayer, respective output vectors of a set of output vectors output from the second feedforward sublayer; and
executing a third feedforward sublayer of an initial layer of the plurality of layers by applying a single nonlinear feedforward network to generate, from each vector of an intermediate set of vectors input to the third feedforward sublayer, respective output vectors of a set of output vectors output from the third feedforward sublayer.
